(19) United States
(12) Patent Application Publication
(10) Pub. No.: US 2012/0021911 A1
(43) Pub. Date: Jan. 26, 2012

(54) Plant Treatment Compositions and Methods for Their Use

(75) Inventors: Wallace Keith Majure, West Monore, LA (US); Nicholas William Vandervort, Cresco, LA (US); Paul Joseph David, Lititz, PA (US); Brian Duane Deeter, Auberry, CA (US); Gary Louis Melchior, Walla Walla, WA (US); James Richard Brazzle, Sancramento, CA (US); Kenneth Roger Muzyk, Brandon, FL (US); Frank Rene Miranda, Holtville, CA (US); Tak Wai Cheung, Yuma, AZ (US); Oakford George Bain, Yuma, AZ (US); John Edward Frieden, Kansas City, MA (US); David Alexander Marsden, Yuma, AZ (US); Olaf Christian Moberg, New Brighton, MN (US); Susan Toddie Oeltjen, Lake Elmo, MN (US); John Christopher Rueb, St. Paul, MN (US); William Arthur Hendrickson, Stillwater, OK (US)

(73) Assignee: Gowan Co., Yuma, AZ (US)

(21) Appl. No.: 13/146,229

(22) PCT Filed: Mar. 5, 2010
(86) PCT No.: PCT/US10/00688

§ 371 Date: Oct. 6, 2011

Related U.S. Application Data
(60) Provisional application No. 61/158,111, filed on Mar. 6, 2009.
(60) Provisional application No. 61/158,882, filed on Mar. 10, 2009.

(51) Int. Cl. A01N 55/02; A01P 21/00; A01P 3/00; A01P 1/00; A01P 13/02

(52) U.S. Cl. 504/140; 514/54

(57) ABSTRACT

Plant treatment compositions comprising metal alginate salts and at least one amine compound are useful in the treatment of plants, particularly food crops. The metal alginate salts are found to be highly effective in the absence of herbicides, fungicides and pesticides.

The present invention relates to plant treatment compositions and methods for their use. More particularly the present invention relates to plant treatment compositions comprising metal alginate salts as compositions useful in the treatment of plants, particularly food crops, methods for the production of such plant treatment compositions, and methods for their use.

The control of pathogentic fungi and bacteria and other diseases is of great economic importance since fungal growth on plants or on parts of plants inhibits production of foliage, fruit or seed, and the overall quality of a cultivated crop.

U.S. Pat. No. 5,977,023 discloses pesticidal compositions which necessarily include both a pesticide, and further necessarily include a pest-controlling active ingredient and/or a plant growth regulating active ingredient with a water insoluble alginate salt. The resultant compositions are granulated or pulvurent compositions which necessarily include both a pest-controlling active ingredient and/or a plant growth regulating active ingredient with the water insoluble alginate salt The compositions of U.S. Pat. No. 5,977,023 are prepared by treating a solid composition containing a pest-controlling active ingredient or a plant growth-regulating active ingredient and an alginic acid or a water-soluble alginate with an aqueous solution containing a divalent or polyvalent cation which can convert the alginic acid or water-soluble alginate into a water-insoluble alginate. Otherwise, the composition of the invention is prepared by coating a solid substance containing a pesticidally active ingredient which is a pest-controlling active ingredient or a plant growth-regulating active ingredient with a water-insoluble alginate. The function of the water-insoluble alginates are cited to impart controlled release, as well as sustained release properties of the pest-controlling active ingredient and/or a plant growth regulating active ingredient.

U.S. Pat. No. 2,983,722 discloses pesticidal compositions which include dual-metal salts depolymerized alginic acid, which depolymerized alginic acids are required in order form the dual-metal salts.

Published patent application US 2007/0010579 discloses certain copper salts of specific organic acids for use as fungicides. Such compositions may be used on plants or on inanimate substrates.

Although the prior art provides a wide variety of chemical compounds and chemical preparations or compositions which are useful as plant treatment compositions for the control of pathogentic fungi and bacteria and other diseases in plants and particularly plant crops, there nonetheless remains a real and urgent need for improved plant treatment compositions which provide such benefits. Likewise there remains a continuing need for improved methods for providing preventive and curative fungicidal activity for the protection of cultivated plants with a minimum of undesired side effects, and with relative safety for animals and humans.

It is to these and other objects that present invention is directed.

In a first aspect there are provided plant treatment compositions comprising metal alginate salts and further containing at least one amine as compositions useful in the treatment of plants, particularly food crops.

In a second aspect there are provided methods for the production of plant treatment compositions comprising metal alginate salts and at least one amine as compositions useful in the treatment of plants, particularly food crops.

A third aspect of the invention relates to methods for the treatment of plants, including food crops in order to control the incidence of and/or spread of pathogentic fungi and bacteria and other diseases in said plants and particularly food crops and providing improved plant health and/or food crop yields.

In a yet further aspect of the invention there are provided plant treatment compositions which are particularly useful in the treatment of tomato plants and for controlling the incidence and spread of undesired bacterial pathogens, e.g., bacterial spot, such as may be caused by genus Xanthomonas, e.g, Xanthomonas campestris pv. vesicatoria; bacterial speck, such as may be caused by genus Pseudomonas e.g., Pseudomonas syringae PV tomato; and citrus canker, such as may be caused by genus Xanthomonas e.g., Xanthomonas axonopodis pv. citri These and other aspects of the invention will be better understood from the following specification.

The present inventors have discovered that plant treatment compositions comprising metal alginate salt compositions and at least one amine compound and/or ammonia are particularly useful in the treatment of plants and/or fields, particularly food crops. Such plant treatment compositions are surprisingly effective when provided in the absence of other biologically active materials, e.g., materials which exhibit or provide pesticidal, disease control, including fungicidal, mildew control or herbicidal or plant growth regulating effects. Such plant treatment compositions underscore the fact that metal alginate salt compositions are very effective when provided in the absence of other biologically active materials they are more attractive for use from an environmental standpoint due to their efficacy even in the absence of other biologically active materials. However the plant treatment compositions comprising metal alginate salt compositions and at least one amine compound and/or ammonia are expected to be useful when provided in conjunction with one or more of aforesaid biologically active materials, and in certain combinations may exhibit synergistic benefits therewith. Plant treatment compositions of the invention may also include one or more non-biologically active materials which are recognized as being useful in the art.

The plant treatment compositions of the invention include one or more metal alginate salts which may be derived from reacting a metal, an inorganic and/or organic compound or species which releases a suitable metal ion, with an alginate in order to form the desired metal alginate salts.

The plant treatment compositions of the invention include one or more metal alginate salts which may be derived from reacting a metal, an inorganic and/or organic compound or species which releases a suitable metal ion, with an alginate in order to form the desired metal alginate salts, but the plant treatment compositions also necessarily include one or more amine compounds selected from: ammonia, primary amines, secondary amines, tertiary amines, as well as salts thereof. The ammonia may be formed in-situ, e.g. by reacting ammonium carbonate with water, or by other means known to the art.

The plant treatment compositions of the invention necessarily include one or more metal alginate salts. The one or more metal alginate salts may be derived from or provided by reacting one or more compounds or complexes comprising the at least one metal selected from the elements represented on Groups 2-12, as well as any of the metals of Groups 13-15 of the Periodic Table of Elements (per IUPAC, 2000). These specifically include the transition metals of the Periodic Table of Elements. Particularly preferred are one or more metals selected from: magnesium, iron, copper, nickel, zinc, aluminum, palladium, cadmium, platinum, lead, and gold, but preferably the metal alginate salts are based on nickel, copper, zinc, aluminum, palladium, silver, or tin, and especially are based on copper. Chemical compounds which may dissociate when combined with water or a largely aqueous solvent to deliver monovalent and/or polyvalent free metal ions are particularly preferred, especially those which may deliver Cu(I), Cu(II), Ag(I), Ag(II) ions which are especially particularly preferred.

Preferred embodiments of the plant treatment compositions of the invention need not include metal alginate salts of the plant treatment compositions which exclusively comprise species of metals selected from magnesium, iron, copper, nickel, zinc, aluminum, palladium, cadmium, platinum, lead, and gold, preferably metal alginate salts based on nickel, copper, zinc, aluminum, palladium, silver, or tin, and especially those based on copper, but may contain a mixture of two or more different metals which are present as a part of the metal alginate salts, such as combinations of two or more of these metals, or even three of more of these metals in being simultaneously present.

It is also to be understood that according to preferred embodiments of the plant treatment compositions of the invention need not include metal alginate salts of the plant treatment compositions which exclusively comprise species of metals selected from magnesium, iron, copper, nickel, zinc, aluminum, palladium, cadmium, platinum, lead, and gold, preferably metal alginate salts based on nickel, copper, zinc, aluminum, palladium, silver, or tin, and especially those based on copper, but may contain a mixture of at least one or more different metals which are present as a part of the metal alginate salts, such as combinations of two or more of these metals, or even three of more of these metals concurrently with one or more non-metallic species such as calcium and/or sodium which may also be present. Accordingly in certain preferred embodiments, it is required that the recited metal alginate salts do necessarily include at least one metal, and may also contain at least one non-metal, but preferably do contain at least one non-metal concurrently with the at least one metal.

In certain embodiments, combinations of at least two different metals, or combinations which contain one or more different metals concurrently with one or more non-metals are preferred. Non-limiting examples of such preferred combinations include:

(A) a copper metal salt and at least one secondary metal salt at least selected from sodium, potassium, magnesium, calcium, barium, aluminum, manganese, iron, cobalt, nickel, copper, zinc, lead, silver, gold, cadmium, tin, palladium, platinum, gold and mixtures thereof;

(B) a silver metal salt and at least one secondary metal salt at least selected from sodium, potassium, magnesium, calcium, barium, aluminum, manganese, iron, cobalt, nickel, copper, zinc, lead, silver, gold, cadmium, tin, palladium, platinum, gold and mixtures thereof;

(C) copper(II) and calcium(II) salts, or copper(II) and zinc(II) salts, or copper(II) and silver(I) salts, or copper(II) and copper(I) salts, or copper(II) and sodium(I) salts, or copper(II) and sodium(I) and calcium(II) salts;

(D) silver(I) and calcium(II) salts, or silver(I) and zinc(II) salts, or silver(II) and silver(I) salts, or silver(I) and aluminum(III) salts, or silver(I) and sodium(I) and calcium (II)salts;

(E) a mixture of copper alginate and calcium alginate and/or a copper, calcium alginate;

(F) a mixture of copper alginate and zinc alginate and/or a copper, zinc alginate;

(G) a mixture of silver alginate and calcium alginate and/or a silver, calcium alginate;

(H) a mixture of silver alginate and zinc alginate and/or a silver, zinc alginate.

In certain preferred embodiments it is also contemplated that the metal alginate salt excludes non-metal salts, e.g., excludes sodium salts.

In still further embodiments it is contemplated the metal alginate salts necessarily include at least one metal, and at least one non-metals especially sodium or potassium salts which may be obtained from are sulfates, chlorides, nitrates, hydroxides, phosphates, carbonates, or mixtures thereof.

While not wishing to be bound by the following, the present inventors believe the presence of two or more metals, and/or the presence of at least one metal and one non-metal may provide for an ion exchange mechanism in the plant treatment compositions which may be beneficial.

The metal alginate salts of the invention may be formed by any conventional means which is currently known to the art, such as by combining metal cations with one or more alginates, e.g. alkali metal salts of alginic acid such as sodium alginate, calcium alginate and/or potassium alginate, silver salts of alginic acid, zinc salts of alginic acid, as well as ammonium salts of alginic acid, in order to form metal alginate salts. Non-limiting examples of divalent or polyvalent cations which can convert an alginic acid or alginate into a metal alginate salt are calcium cations, magnesium cations, barium cations, zinc cations, nickel cations, copper cations, (especially preferably those which provide Cu(I) and Cu(II) cations) silver cations (especially preferably those which provide Ag(I) and Ag(II) cations) and lead cations. Examples of particular aqueous solutions containing a cation include ones which contain calcium salts such as aqueous solutions of calcium chloride, calcium nitrate, calcium lactate, and calcium citrate, those containing magnesium salts such as aqueous solutions of magnesium chloride, magnesium nitrate, those containing barium salts such as aqueous solutions of barium chloride, those containing zinc salts such as aqueous solutions of zinc chloride, zinc nitrate, and zinc sulfate, those containing nickel salts such as aqueous solutions of nickel chloride, those containing copper salts such as aqueous solutions of copper sulfate, copper chloride, copper nitrate, copper oxychloride or any other chemical species which may be used to provide Cu(I) and especially Cu(II) cations in an aqueous composition. In such solutions, the content of the cation salt may be of any effective amount but advantageously is usually 1% by weight through saturated concentration, preferably 5% by weight through saturated concentration in aqueous solution.

Alginates may be based on alginic acids which may be generally represented by the structure:

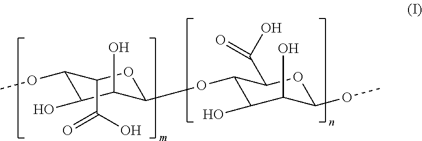

wherein m and n, independently are integers having values of sufficient magnitudes to provide a polymer of a suitable molecular weight. Typically, as indicated in formula (I) above, alginates are natural block copolymers extracted from seaweed and consist primarily (preferably essentially of, viz. contain at least 99.8% wt.) of uronic acid units, specifically 1-4-a, L-guluronic and 1-b, D-mannuronic acid which are connected by 1:4 glycosidic linkages. Such alginates are typically sold in a sodium salt form but different commercial grades may also contain varying amounts of other ions, including calcium ions. Examples of commercially available grades of alginates include those sold under one or more of the following tradenames: MANUTEX® including MANUTEX® RM (approx. molecular weight of 120,000-190,000) and MANUTEX® RD (approx molecular weight of 12,000-80,000), MANUGEL® including MANUGEL® GMB (approx. molecular weight of 80,000-120,000), MANUGEL® GHB (approx. molecular weight of 80,000-120,000), and MANUGEL® LBA, MANUGEL® DBP, KELTONE® including KELTONE® HV (approx. molecular weight of 120,000-180,000), KELTONE® LV (approx. molecular weight of 80,000-120,000), KELCOSOL® (approx. molecular weight of 120,000-190,000). Representative alginates having an excess of guluronic acid to mannuronic acid are MANUGEL® LBA, MANUGEL® DBP and MANUGEL® GHB wherein the ratio of guluronic acid units to mannuronic acid units are higher than a respective 1:1 ratio. Such are referred to as high guluronic alginates. MANUGEL® LBA, MANUGEL® DBP and MANUGEL® GHB have guluronic acid unit to mannuronic acid unit ratios of about 1.5:1. Representative alginates considered as low guluronic alginates, viz. those having a ratio of less than 1:1 of guluronic acid units to mannuronic acid units include KELTONE® HV and KELTONE® LV, which have guluronic acid unit to mannuronic acid unit ratios of about 0.6-0.7:1. In certain particularly preferred embodiments of the invention, high guluronic alginates are preferred for use in the plant treatment compositions.

The alginate can exhibit any number average molecular weight range, such as a high molecular weight range (about 2.05×10⁵ to about 3×10⁵ Daltons or any value therebetween; examples include MANUGEL® DPB, KELTONE® HV, and TIC 900 Alginate); a medium molecular weight range (about 1.38×10⁵ to about 2×10⁵ Daltons or any value therebetween; examples include MANUGEL® GHB); or a low molecular weight range (about 2×10 to about 1.35×10⁵ Daltons or any value therebetween; examples include MANUGEL® LBA and MANUGEL® LBB). Number average molecular weights can be determined by those having ordinary skill in the art, e.g., using size exclusion chromatography (SEC) combined with refractive index (RI) and multi-angle laser light scattering (MALLS).

Low-molecular through high-molecular weight alginates acids can be used in the compositions of the present invention, the molecular weight of the alginic acid or alginate is typically 500 through 10,000,000 Daltons, preferably 1,000 through 5,000,000 Daltons, and most preferably 3,000 through 2,000,000 Daltons. The alginic acid or alginate may be used in admixture of those having different molecular weights. Furthermore mixtures of two or more different alginates and/or metal alginate salts may also be used in the plant treatment compositions of the invention.

The amounts of metal alginate salts in the plant treatment compositions of the invention may vary widely and in part, depend upon the form of the product of the plant treatment compositions. Generally speaking the metal alginate salts may be provided in amounts of as little as 0.000001% wt. to as much as 100% wt (0.01 ppm to 1,000,000 ppm). of the plant treatment composition of which it forms a part. For example, higher concentrations are to be expected wherein the form of the plant treatment composition is a concentrate or super-concentrate composition which is provided to a user such as a plant grower with instructions to form a dilution in a liquid or solid carrier, e.g., water or other solvent, prior to application to plants. Lesser concentrations are expected wherein the plant treatment composition is provided as a ready-to-use product which is intended to be dispensed directly without further dilution from any container onto a plant. The plant treatment compositions of the invention may be applied “neat” in water, or as part of a “tank mix” with other materials or constituents.

While not wishing to be bound by theory, it is believed that the presence of the amine compound forms a complex with the metal cations which thus bind these metal ions and reduce the reactivity of the metal cations with the alginic acid or alginate until such time that, after application onto a plant or crop a major proportion of the liquid carrier, e.g., water, at least partially evaporates and thereafter the metal cations then form the desired metal alginate salts, in situ on the surface of the plant or crops being treated. The inventors have noted that the use of the amine compound, especially ammonia, readily complexes with the available monovalent and polyvalent metal ions, especially wherein such are Cu(I), Cu(II), Ag(I) or Ag(II) ions present, and in accordance with a preferred process of the invention, the plant treatment compositions are formed by at least a two step process wherein in a first step, one or more suitable sources of metal ions are contacted with one or more amine compounds in a suitable reaction medium, e.g., water or other solvent, in order to form a nitrogen containing metal complex, and thereafter in a subsequent process step the nitrogen containing metal complex is combined with the alginate, e.g., sodium alginate, calcium alginate and/or alginic acid, usually in a suitable reaction medium, e.g., water or other solvent, in order to form one form a preferred form of the plant treatment composition of the invention. Such a two step process may be used to form both concentrated forms of the plant treatment compositions of the invention, or may be used to form ready to use plant treatment compositions of the invention. Such also permits for providing the plant treatment compositions as two or more separate components or materials which are combined prior to, or on the plant, plant part or crop to form the plant treatment compositions of the invention. For example such may be attained by providing two or more separate compositions in a kit or package which are intended to be combined by the ultimate product user in order to form the plant treatment compositions.

The inventors have surprisingly found that plant treatment compositions formed by such a two step process exhibit physical handling properties and also feature excellent storage stability, particularly wherein the plant treatment compositions exclude the amine compound. The improved physical handling characteristics and improved storage stability, as compared to similar compositions which exclude the amine compound, permit for the production of plant treatment compositions in both concentrated form, or in a ready to use form, which has a longer shelf life, exhibit good storage stability even under adverse conditions, and thus are of commercial significance.

As distinguished from plant treatment compositions which may be previously formed or formulated, e.g., weeks or months before actual use on a plant, plant part or crop, the plant treatment compositions may also be formed directly on the plant, plant surface or crop by providing a first composition containing the alginate or alginic acid preferably in a suitable carrier, e.g., water, and optionally including further constituents other than the amine compound and the inorganic and/or organic compound or species which releases a suitable metal ion, particularly Cu(I), Cu(II), Ag(I), Ag(II) cations, and separately providing a second composition which contains the amine compound and the inorganic and/or organic compound or species which releases a suitable metal ion, particularly Cu(I), Cu(II), Ag(I), Ag(II) cations, preferably in a suitable carrier, e.g., water, and which optionally contains further constituents, and combining the said first composition with said second composition to form the plant treatment composition shortly prior to application onto a plant, plant surface or crop, or alternately, applying the said first composition and the said second composition sequentially to a plant, plant surface, or crop, such that the desired metal alginate is formed in situ, directly upon the plant, plant surface or crop. Such an application process provides for the practice of the invention according to processes wherein the inorganic and/or organic compound or species which releases a suitable metal ion, particularly Cu(I), Cu(II), Ag(I), Ag(II) cations is physically separated from the alginic acid or alginate salt (e.g., sodium alginate salt, calcium alginate salt) until just shortly prior to application, e.g., such as may be practiced by providing a first composition and a second composition outlined above to tank containing one or more further constituents but especially a carrier, e.g., water, in order to form the plant treatment composition directly in the tank and just before application to plants or crops, such as by spraying. Alternately such an application process provides for the practice of the invention according to processes wherein the said first composition and said second composition may be separately provided by spray apparatus as two distinct streams which are mixed at the inlet of, or within a nozzle of a sprayer. Alternately such an application process also provides for the practice of the invention according to a process wherein said first composition is separately applied, such as by spraying, onto a plant, plant surface or crop, and thereafter said second composition is applied, such as by spraying, onto a plant, plant surface or crop, such that the first composition and the second composition mix on the surface of the plant, or on the crop to which both compositions have been applied. The mixing on the surface of the plant or crop permits for the in situ formation of the metal alginate salt, preferably the preferred Cu(I), Cu(II), Ag(I), Ag(II) cations. These processes may also be advantageously practiced by reversing the order of addition of, or the application of, the said first and said second compositions, e.g, by applying the second composition prior to tank mix, or to the plant or crop, followed by application of the first composition as the order of addition or that of application is not critical, rather it is only required that the alginic acid or alginate salt be kept separate from the inorganic and/or organic compound or species which releases a suitable metal ion, particularly Cu(I), Cu(II), Ag(I); Ag(II) cations, until shortly prior to application onto a plant, plant surface or crop.

In a further aspect of the invention there are provided plant treatment compositions which may be formed directly on the plant, plant surface or crop by providing a first composition containing the alginate or alginic acid preferably in a suitable carrier, e.g., water, and optionally including further constituents other than the inorganic and/or organic compound or species which releases a suitable metal ion, particularly Cu(I), Cu(II), Ag(I), Ag(II) cations, and separately providing a second composition which contains the inorganic and/or organic compound or species which releases a suitable metal ion, particularly Cu(I), Cu(II), Ag(I), Ag(II) cations, preferably in a suitable carrier, e.g., water, and which optionally contains further constituents, and combining the said first composition with said second composition to form the plant treatment composition shortly prior to application onto a plant, plant surface or crop, or alternately, applying the said first composition and the said second composition sequentially to a plant, plant surface, or crop, such that the metal alginate is formed in situ, directly upon the plant, plant surface or crop. Due to the physical separation of the first composition from the second composition until shortly prior to application onto a plant, plant surface or crop, the inventors have found that the amine compound is not required and may be omitted. Such an application process provides for the practice of the invention according to processes wherein the inorganic and/or organic compound or species which releases a suitable metal ion, particularly Cu(I), Cu(II), Ag(I), Ag(II) cations is physically separated from the alginic acid or alginate salt (e.g., sodium alginate salt, calcium alginate salt) until just shortly prior to application, e.g., such as may be practiced by providing a first composition and a second composition outlined above to tank containing one or more further constituents but especially a carrier, e.g., water, in order to form the plant treatment composition directly in the tank and just before application to plants or crops, such as by spraying. Alternately such an application process provides for the practice of the invention according to processes wherein the said first composition and said second composition may be separately provided by spray apparatus as two distinct streams which are mixed at the inlet of or within a nozzle of a sprayer. Alternately such an application process also provides for the practice of the invention according to a process wherein said first composition is separately applied, such as by spraying, onto a plant, plant surface or crop, and thereafter said second composition is applied, such as by spraying, onto a plant, plant surface or crop, such that the first composition and the second composition mix on the surface of the plant, or on the crop to which both compositions have been applied. The mixing on the surface of the plant or crop permits for the in situ formation of the metal alginate salt, preferably the preferred Cu(I), Cu(II), Ag(I); Ag(II) cations. These processes may also be advantageously practiced by reversing the order of addition of, or the application of, the said first and said second compositions, e.g, by applying the second composition prior to tank mix, or to the plant or crop, followed by application of the first composition as the order of addition or that of application is not critical, rather it is only required that the alginic acid or alginate salt be kept separate from the suitable metal ion, particularly Cu(I), Cu(II), Ag(I), Ag(II) cations until shortly prior to application onto a plant, plant surface or crop.

In the foregoing outlined processes, it is to be understood that the clause “shortly prior to application onto a plant, plant surface or crop” is to be understood in the context that the first said composition and the second said composition are combined with one another, optionally with one or more further constituents but preferably within a suitable carrier, not more than 24 hours, preferably not more than 18 hours, and in order of increasing preference, not more than 12 hours, 10 hours, 8 hours, 6 hours, 5 hours, 4 hours, 3 hours, 2 hours, 1 hour, 0.75 hour, 0.5 hour, 0.25, 0.1 hour, and 0.05 hour prior to dispensing by a suitable or conventional means or device, e.g., sprayer, and onto a plant, plant part or crop. In the foregoing outlined processes, wherein a first composition is applied to a plant by a first application step, followed by a separate application of the second composition in a second application step, preferably the time interval between the said first application step and the second application step is not more 6 hours, preferably not more than 4 hours, and in order of increasing preference, not more than 3 hours, 3.5 ours, 2 hours, 2.5 hours, 2 hours, 1.5 hours, 1 hour, 0.75 hour, 0.5 hour, 0.25 hour, and especially preferably not more than 0.1 hour. Particularly advantageously the said first application step and the second application step are practiced not more than 5 minutes apart, and in a particularly preferred process embodiment the said first composition and the second composition are either separately but simultaneously delivered from separate supply means, e.g., spray nozzles or jets, onto plants, plant surfaces or crops wherein the said first composition and second composition mix, or in a further particularly preferred process embodiment the said first composition and the second composition are separately supplied from separate supply sources to supply means, e.g., spray nozzles or jets, and are mixed immediately prior to being supplied to the supply means, or are mixed within the supply means such that the mixture of first composition and the second composition occurs not more than 15 seconds, preferably not more than 10 seconds, still more preferably and in order of increasing preference: not more than 8 seconds, 7 seconds, 6 seconds, 5 seconds, 4 seconds, 3 seconds, 2 seconds, 1 second, 0.5 second, before being delivered from the supply means and onto plants, plant surfaces or crops.

The plant treatment composition of the invention may also be formed by combining the first composition with the second composition, optionally with further constituents, e.g., a carrier in a vessel, such as a tank if to be applied shortly after mixing or in a storage tank if to be applied at a later date. Advantageously the plant treatment composition of the invention may also be formed by combining the first composition with the second composition, optionally with further constituents, e.g., a carrier shortly prior to application onto a plant, plant surface or crop. Mixing need not occur on the surface of the plant, or on the crop or prior to the nozzle or within the nozzle or spray head as outlined above.

Advantageously, the final end-use concentration of the one or more metal alginate salts in the plant treatment compositions, viz., the concentration of the one or more metal alginate salts in the plant treatment compositions which are in the form as applied to seeds, plants or for that matter soil, are those which are found to be effective in the treatment of a particular plant or crop, which amount is understood to be variable, as it may be affected by many factors, including but not limited to: type of plant or crop treated, treatment dosages and application rates, weather and seasonal conditions experienced during the plant or crop growing cycle, etc. Such variables are which are commonly encountered by and understood by the skilled artisan, who may make adjustments to the treatment regimen, e.g., application rate, and/or application timings and/or application frequencies. Advantageously the concentration of the one or more metal alginate salts in such end-use plant treatment compositions can be such to provide as little as 0.01 ppm, to 500,000 ppm of the metal ion(s) used to form the metal alginate salt, but preferably are between 0.01 ppm and 100,000 ppm of the metal ion(s) used to form the alginate salt, as applied to the plant or alternately as present in an end-use concentration such as a ready to use or ready to apply composition intended to be applied to a plant, plant part or crop. Surprisingly the inventors have found that the metal alginate salts of the plant treatment compositions in such final end-use concentrations or as applied to a plant concentration are effective in the treatment of plants in amounts which are typically less, and frequently far less than the amounts of the active amounts of conventional pest-controlling active ingredient and/or a plant growth-regulating active ingredient, viz., herbicidal, fungicidal or pesticidal compounds which are necessary in order to provide a comparable benefit level. Preferably the plant treatment compositions thus contain from about 0.5 ppm to 500,000 ppm, preferably from about 1 ppm to about 50,000 ppm and especially preferably from about 1 ppm to about 25,000 ppm of the metal ion(s) used to form the metal alginate salt being provided by the plant treatment composition, in the form as applied to the plant, plant part or crop. In certain particularly preferred embodiment the plant treatment compositions thus contain from about 0.5 ppm to about 25,000 ppm and in order of increasing preference not more than: 24,000 ppm, 23,000 ppm, 22,000 ppm, 21,000 ppm, 20,000 ppm, 19,000 ppm, 18,000 ppm, 17,000 ppm, 16,000 ppm, 15,000 ppm, 14,000 ppm, 13,000 ppm, 12,000 ppm, 11,000 ppm, 10,000 ppm, 9,000 ppm, 8,000 ppm, 7,000 ppm, 6,000 ppm, 5,000 ppm, 4,000 ppm, 3,000 ppm, 2,000 ppm. and 1,000 ppm, 900 ppm, 800 ppm, 700 ppm, 600 ppm, 500 ppm, 400 ppm, 300 ppm, 200 ppm or even less in certain embodiments.

The inventors have also unexpectedly discovered that the use of the metal alginate salts permits for the application at lower rates than certain metal-based commercial products (e.g., KOCIDE, ex. E.I. DuPont de Nemours), as it is believed that the applied coverage of the product permits for a more uniform, and more complete application permits for the improved deposition and retention of the compositions on plant surfaces.

The inventors have also surprisingly discovered that the metal alginate salts, particularly those based on copper salts show surprisingly good efficacy against certain copper resistant strains or pathogens on plants, which has not been effectively treated by prior art commercially available preparations, e.g. KOCIDE 2000. It is expected that such salts based on or including other metals, especially silver, are also expected to provide good results.

Contrary to U.S. Pat. No. 5,977,023, the present inventors have discovered that their plant treatment compositions can provide an effective treatment composition for control of pathogentic fungi and bacteria and other diseases in plants and particularly plant crops even in the absence of a pest-controlling active ingredient and/or a plant growth-regulating active ingredient. In certain preferred embodiments of the plant treatment compositions of the invention, such pest-controlling active ingredients and/or plant growth-regulating active ingredients are absent and are excluded from the plant treatment compositions of the invention.

Copper alginate salts are found to be economically feasible, and have been proven to be effective as is disclosed in one or more of the examples illustrated below. Further useful alginate salts are discussed following. However, the use of other metals or metallic cations although not expressly demonstrated in one or more the following examples is nonetheless is contemplated to be within the scope of the present invention.

The plant treatment compositions include one or more amine compounds selected from: ammonia, primary amines, secondary amines or tertiary amines, as well as salts thereof. By way of non-limiting example, exemplary primary amines include methylamine, ethanolamine; exemplary secondary amines include dimethylamine, diethylamine, and cyclic amines such as aziridine, azetidine, pyrrolidine and piperidine; exemplary tertiary amines include trimethylamine. Further amines include ethylenediamine, diethyeneltriamine, triethylenetetramine, tetraethylenepentamine, piperazine, aminoethylpiperazine, aminoethylethanolamine, hydroxyethylpiperazine, methyldiethylenetriamine. Such amine compounds include those which would form a complex with the one or more compounds or complexes comprising the at least one metal selected from the elements represented on Groups 2-12, as well as any of the metals of Groups 13-15 of the Periodic Table of Elements ultimately used in the formation of the metal alginate salts of the plant treatment compositions taught herein. The ammonia may also be formed in situ by a suitable reaction, e.g., the reaction of ammonium carbonate with water.

Notwithstanding the above it is to be understood that the plant treatment compositions taught herein may omit the one or more amine compounds selected from: ammonia, primary amines, secondary amines or tertiary amines, as well as salts thereof if the plant treatment compositions are provided as two or more separate components, one of which components comprises the alginate or alginic acid and optional constituents, e.g. a carrier, and the metal, an inorganic and/or organic compound or species which releases a suitable metal ion and optional constituents, e.g., a carrier, such that the desired metal alginate salts are formed shortly prior to application onto a plant, plant surface or crop.

Although it is contemplated that while the plant treatment compositions of the invention may be provided in a powdered or pulvurent form, it is expected that the plant treatment compositions are provided in a liquid, gel, foam or paste form. The plant treatment compositions are advantageously provided in a liquid carrier system, e.g., in an aqueous or other fluid carrier which permits for the convenient mixing of a measured quantity of a concentrated form of the plant treatment compositions with a larger volume of water or other fluid carrier in which the concentrated form is diluted, such as in forming a tank mix, or the plant treatment compositions may be provided in a form such that no further dilution is required and such plant treatment compositions may be used directly in the treatment of plants.

While not wishing to be bound by the following hypothesis, it is believed that the metallic salt alginates have a degree of surface “tackiness” when a formulation containing the same is applied from an aqueous solution to plant surfaces, and that at least the metallic salt alginate adhere to the plant foliage, fruit or crop to which it has been applied. This tackiness increases the amount of metallic salt alginates which adhere to the plant matter surfaces and also retains the metallic salt alginates on the plant surfaces which is believed to enhance their durability and retention on plant surfaces, and thereby provide a longer lasting benefit. While the mechanism is not clearly understood, it has nonetheless surprisingly been observed that the metal alginate salts appear to provide a beneficial effect even in the absence of conventional pesticides, fungicides, or herbicides particularly as is demonstrated in one or more of the following examples. It is hypothesized that the metal contributes to the beneficial effect.

Thus according to certain embodiments, in one aspect, the present invention provides plant treatment compositions which include a metal alginate salt and/or metal salt of an alginic acid, preferably wherein the metal alginate salts are copper salts or silver salts, and especially preferably wherein the composition includes a sufficient amount of copper alginates which ultimately provides between 0.5 ppm and 50,000 ppm of metallic copper in the form of Cu(I) and/or Cu(II) ions as applied to a plant or plant part, and a liquid carrier, preferably a liquid carrier which is water or which is a largely aqueous liquid carrier, with the proviso that the plant treatment compositions include amine compounds selected from: ammonia, primary amines, secondary amines or tertiary amines, as well as salts thereof.

According to yet further preferred embodiments, in a further aspect, the present invention provides plant treatment compositions which include a metal alginate salt and/or metal salt of an alginic acid, preferably wherein the metal alginate salts are copper salts or silver salts, and especially preferably wherein the composition includes a sufficient amount of copper alginates which ultimately provides between 0.5 ppm and 50,000 ppm of metallic copper in the form of Cu(I) and/or Cu(II) ions as applied to a plant or plant part, and a liquid carrier, preferably a liquid carrier which is water or which is a largely aqueous liquid carrier, with the proviso that the plant treatment compositions include one or more amine compounds selected from: ammonia, primary amines, secondary amines or tertiary amines, as well as salts thereof, and the further proviso that the plant treatment compositions also exclude biologically active materials which exhibit or provide pesticidal, disease control, including fungicidal, mildew control or herbicidal or plant growth regulating effects.

In yet another aspect of the invention there are provided plant treatment compositions of the invention which are provided at least two separate constituents, one of the constituents comprising the alginic acid or alginate and optional constituents, while a separate component comprises the metal, an inorganic and/or organic compound or species which releases a suitable metal ion and optional constituents, such that the desired metal alginate salts are formed shortly prior to application onto a plant, plant surface or crop. Such plant treatment compositions provided by the foregoing method may omit, and preferably do exclude, the one or more amine compounds selected from: ammonia, primary amines, secondary amines or tertiary amines, as well as salts thereof which would form a complex with the suitable metal ions intended to form the metal alginate salts. Preferably in such plant treatment compositions the metal alginate salts are copper salts or silver salts, and especially preferably wherein the composition includes a sufficient amount of copper alginates which ultimately provides between 0.5 ppm and 50,000 ppm of metallic copper in the form of Cu(I) and/or Cu(II) ions as applied to a plant or plant part.

In addition to the essential constituents disclosed above, the plant treatment compositions of the invention may include one or more further additional optional constituents which may be used to provide one or more further technical effects or benefits to the plant treatment compositions.

Optionally, but in certain cases preferably, the plant treatment compositions of the invention include adhesion promoters and/or plasticizers. Such materials enable a better and longer lasting adhesion of the plant treatment compositions of the invention to the surfaces being treated, e.g., plant surfaces, etc.

Once class of exemplary adhesion promoters include gelatinizing substances which include, but are not limited to, paraffin wax, beeswax, honey, corn syrup, cellulose carboxy-methylether, guar gum, carob gum, tracanth gum, pectin, gelatine, agar, cellulose carboxy-methylether sodium salt, cellulose, cellulose acetate, dextrines, cellulose-2-hydroxyethylether, cellulose-2-hydroxypropylether, cellulose-2-hydroxypro-pylmethylester, cellulosemethylether, cornstarch, sodium alginate, maltodextrin, xanthan gum, epsilon-caprolactampolymer, dia-tomeen soil, acrylic acid polymers, PEG-30 glyceryl-cocoat, PEG-200, hydrogenated glyceryl-palmitate, and any combinations thereof. In one example, an acrylic acid polymer is an acrylic acid polymer that is sold under the brand name Carbomar® (ex. Degussa.). A further class of exemplary adhesion promoters include Further suitable adhesive promoters include block copolymers EO/PO surfactants, as well as polymers such as polyvinylalcohols, polyvinylpyrrolidones, polyacrylates, polymethacrylates, polybutenes, polyisobutylenes, polystyrene, polyethyleneamines, polyethyleneamides, polyethyleneimines (Lupasol®, Polymin®), polyethers and copolymers derived from these polymers.

One or more plasticizers may also be present in the plant treatment compositions according to the invention, and many plasticizers may also function as adhesion promoters as well. Typically plasticizers are low molecular weight organic compounds generally with molecular weights between 50 and 1000. Examples include, but are not limited to: polyols (polyhydric alcohols), for example alcohols with many hydroxyl groups such as glycerol, glycerin, ethylene glycol, diethylene glycol, triethylene glycol, propylene glycol, dipropylene glycol, polyethylene glycol; polar low molecular weight organic compounds, such as urea, sugars, sugar alcohols, oxa diacids, diglycolic acids; and other linear carboxylic acids with at least one ether group, C₁-C₁₂ dialkyl phthalates. Further non-limiting examples of further useful plasticizers include ethanolacetamide; ethanolformamide; triethanolamines such as triethanolamine acetate; thiocyanates, such as sodium and ammonium thiocyanates.

When present, the adhesion promoters and/or plasticizers typically comprise between 0.0001% wt. to about 10% wt., when the plant treatment compositions are provided as a concentrated composition, and alternately the adhesion promoters typically comprise between 0.01% wt. to about 1% wt., when the plant treatment compositions are provided as a either a tank mixed composition or ready-to use composition. It is understood that the adhesion promoter may be supplied as a separate constituent and not form a constituent of a concentrated composition the plant treatment compositions, but may be added as a co-constituent to a larger volume of a carrier, e.g., water such as when forming a tank mix composition for use.

In certain particularly preferred compositions of the invention an adhesion promoter and/or plasticizer is necessarily present as an essential constituent.

The plant treatment compositions of invention may optionally include one or more constituents or materials especially other biologically active materials, e.g., materials which exhibit or provide pesticidal, disease control, including fungicidal, mildew control or herbicidal or plant growth regulating effects, as well as one or more non-biologically active materials.

By way of nonlimiting examples, examples of biologically active materials include materials which exhibit or provide pesticidal, disease control, including fungicidal, mildew control or herbicidal or plant growth regulating effects

Exemplary fungicides which may be used in the plant treatment compositions of the invention include one or more of: 2-phenylphenol; 8-hydroxyquinoline sulfate; AC 382042; Ampelomyces quisqualis; Azaconazole; Azoxystrobin; Bacillus subtilis; Benalaxyl; Benomyl; Biphenyl; Bitertanol; Blasticidin-S; Bordeaux mixture; Borax; Bromuconazole; Bupirimate; Calboxin; calcium polysulfide; Captafol; Captan; Carbendazim; Carpropanmid (KTU 3616); CGA 279202; Chinomethionat; Chlorothalonil; Chlozolinate; copper hydroxide; copper naphthenate; copper oxychloride; copper sulfate; cuprous oxide; Cymoxanil; Cyproconazole; Cyprodinil; Dazomet; Debacarb; Dichlofluanid; Dichlomezine; Dichlorophen; Diclocymet; Dicloran; Diethofencarb; Difenoconazole; Difenzoquat; Difenzoquat metilsulfate; Diflumetorim; Dimethirimol; Dimethomorph; Diniconazole; Diniconazole-M; Dinobuton; Dinocap; diphnenylamine; Dithianon; Dodemorph; Dodemorph acetate; Dodine; Dodine free base; Edifenphos; Epoxiconazole (BAS 480F); Ethasulfocarb; Ethirimol; Etridiazole; Famoxadone; Fenamidone; Fenarimol; Fenbuconazole; Fenfin; Fenfuram; Fenhexamid; Fenpiclonil; Fenpropidin; Fenpropimorph; Fentin acetate; Fentin hydroxide; Ferbam; Ferimzone; Fluazinam; Fludioxonil; Fluoroimide; Fluquihconazole; Flusilazole; Flusulfamide; Flutolanil; Flutriafol; Folpet; formaldehyde; Fosetyl; Fosetyl-aluminum; Fuberidazole; Furalaxyl; Fusarium oxysporum; Gliocladium virens; Guazatine; Guazatine acetates; GY-81; hexachlorobenzene; Hexaconazole; Hymexazol; ICIA0858; IKF-916; Imazalil; Imazalil sulfate; Imibenconazole; Iminoctadine; Iminoctadine triacetate; Iminoctadine tris[Albesilate]; Ipconazole; Iprobenfos; Iprodione; Iprovalicarb; Kasugamycin; Kasugamycin hydrochloride hydrate; Kresoxim-methyl; Mancopper; Mancozeb; Maneb; Mepanipyrim; Mepronil; mercuric chloride; mercuric oxide; mercurous chloride; Metalaxyl; Metalaxyl-M; Metam; Metam-sodium; Metconazole; Methasulfocarb; methyl isothiocyanate; Metiram; Metominostrobin (SSF-126); MON65500; Myclotbutanil; Nabam; naphthenic acid; Natamycin; nickel bis(dimethyldithiocarbamate); Nitrothal-isopropyl; Nuarimol; Octhilinone; Ofurace; oleic acid (fatty acids); Oxadixyl; Oxine-copper; Oxycarboxin; Penconazole; Pencycuron; Pentachlorophenol; pentachlorophenyl laurate; Perfurazoate; phenylmercury acetate; Phlebiopsis gigantea; Phthalide; Piperalin; polyoxin B; polyoxins; Polyoxorim; potassium hydroxyquinoline sulfate; Probenazole; Prochloraz; Procymidone; Propamocarb; Propamocarb Hydrochloride; Propiconazole; Propineb; Pyrazophos; Pyributicarb; Pyrifenox; Pyrimethanil; Pyroquilon; Quinoxyfen; Quintozene; RH-7281; sec-butylamine; sodium 2-phenylphenoxide; sodium pentachlorophenoxide; Spiroxamine (KWG 4168); Streptomyces griseoviridis; sulfur; tar oils; Tebuconazole; Tecnazene; Tetraconazole; Thiabendazole; Thifluzamide; Thiophanate-methyl; Thiram; Tolclofos-methyl; Tolylfluanid; Triadimefon; Triadimenol; Triazoxide; Trichoderma harzianum; Tricyclazole; Tridemorph; Triflumizole; Triforine; Triticonzole; Validamycin; vinclozolin; zinc naphthenate; Zineb; Ziram; the compounds having the chemical name methyl (E,E)-2-(2-(1-(1-(2-pyridyl)propyloxyimino)-1-cyclopropylmethyloxymethyl) phenyl)-3-ethoxypropenoate and 3-(3,5-dichlorophenyl)-4-chloropyrazole.

When present the one or more fungicides, may be included in any effective amount, and advantageously are present in amounts of from 1 ppm to 50,000 ppm, preferably 10 ppm to 10,000 ppm based on total weight of the plant treatment composition of which it forms a part, as applied to the plant. The concentration of such one or more fungicides will of course be expected to be higher when present in a concentrated form of the composition of the invention, e.g., a concentrate form which is supplied to the ultimate user of the produce, e.g. grower, wherein such a concentrate is intended to be diluted in a liquid and/or solid carrier, e.g., largely aqueous tank mixes wherein the dilution ratio of the concentrate form to the liquid and/or solid carrier is intended to provide a plant treatment composition to be used directly upon plants or crops.

Exemplary pesticides include insecticides, acaricides and nematocides, which be used singly or in mixtures in the plant treatment compositions of the invention. By way of non-limiting example such include one or more of: Abamectin; Acephate; Acetamiprid; oleic acid; Acrinathrin; Aldicarb; Alanycarb; Allethrin [(1R) isomers]; .alpha.-Cypermethrin; Amitraz; Avermectin B I and its derivatives, Azadirachtin; Azamethiphos; Azinphos-ethyl; Azinphosmethyl; Bacillus thurigiensi; Bendiocarb; Benfuracarb; Bensultap; .beta.-cyfluthrin; .beta.-cypermethrin; Bifenazate; Bifenthrin; Bioallathrin; Bioallethrin (S-cyclopentenyl isomer); Bioresmethrin; Borax; Buprofezin; Butocarboxim; Butoxycarboxim; piperonyl butoxide; Cadusafos; Carbaryl; Carbofuran; Carbosulfan; Cartap; Cartap hydrochloride; Chordane; Chlorethoxyfos; Chlorfenapyr; Chlorfenvirnphos; Chlorfluazuron; Chlormephos; Chloropicrin; Chlorpyrifos; Chlorpyrifos-methyl; mercurous chloride; Coumaphos; Cryolite; Cryomazine; Cyanophos; calcium cyanide; sodium cyanide; Cycloprothrin; Cyfluthrin; Cyhalothrin; cypermethrin; cyphenothrin [(1R) transisomers]; Dazomet; DDT; Deltamethrin; Demeton-S-methyl; Diafenthiuron; Diazinon; ethylene dibromide; ethylene dichloride; Dichlorvos; Dicofol; Dicrotophos; Diflubenzuron; Dimethoate; Dimethylvinphos; Diofenolan; Disulfoton; DNOC; DPX-JW062 and DP; Empenthrin [(EZ)-(1R) isomers]; Endosulfan; ENT 8184; EPN; Esfenvalerate; Ethiofencarb; Ethion; Ethiprole having the chemical name 5-amino-3-cyano-1-(2,6-dichloro-4-trifluoromethylphenyl)-4-ethylsulfinylpyrazole; Ethoprophos; Etofenprox; Etoxazole; Etrimfos; Famphur; Fenamiphos; Fenitrothion; Fenobucarb; Fenoxycarb; Fenpropathrin; Fenthion; Fenvalerate; Fipronil and the compounds of the arylpyrazole family; Flucycloxuron; Flucythrinate; Flufenoxuron; Flufenprox; Flumethrin; Fluofenprox; sodium fluoride; sulfuryl fluoride; Fonofos; Formetanate; Formetanate hydrochloride; Formothion; Furathiocarb; Gamma-HCH; GY-81; Halofenozide; Heptachlor; Heptenophos; Hexaflumuron; sodium hexafluorosilicate; tar oils; petroleum oils; Hydramethylnon; hydrogen cyanide; Hydroprene; Imidacloprid; Imiprothrin; Indoxacarb; Isazofos; Isofenphos; Isoprocarb; Methyl isothiocyanal; Isoxathion; lambda-Cyhalothrin; pentachlorophenyl laurate; Lufenuron; Malathion; MB-599; Mecarbam; Methacrifos; Methamidophos; Methidathion; Methiocarb; Methomyl; Methoprene; Methoxychlor; Metolcarb; Mevinphos; Milbemectin and its derivatives; Monocrotophos; Naled; nicotine; Nitenpyram; Nithiazine; Novaluron; Omethoate; Oxamyl; Oxydemeton-methyl; Paecilomyces fumosoroseus; Parathion; Parathion-methyl; pentachlorophenol; sodium pentachlorophenoxide; Permethrin; Penothrin [(1R)-trans-isomers]; Phenthoate; Phorate; Phosalone; Phosmet; Phosphamidon; phosphine; aluminum phosphide; magnesium phosphide; zinc phosphide; Phoxim; Pirimicarb; Pirimiphos-ethyl; Pirimiphos-methyl; calcium polysulfide; Prallethrin; Profenfos; Propaphos; Propetamphos; Propoxur; Prothiofos; Pyraclofos; pyrethrins (chrysanthemates, pyrethrates, pyrethrum; Pyretrozine; Pyridaben; Pyridaphenthion; Pyrimidifen; Pyriproxyfen; Quinalphos; Resmethrin; RH-2485; Rotenone; RU 15525; Silafluofen; Sulcofuron-sodium; Sulfotep; sulfuramide; Sulprofos; Ta-fluvalinate; Tebufenozide; Tebupirimfos; Teflubenzuron; Tefluthrin; Temephos; Terbufos; Tetrachlorvinphos; Tetramethrin; Tetramethrin [(1R) isomers]; .theta.-cypermethrin; Thiametoxam; Thiocyclam; Thiocyclam hydrogen oxalate; Thiodicarb; Thiofanox; Thiometon; Tralomethrin; Transfluthrin; Triazamate; Triazophos; Trichlorfon; Triflumuron; Trimethacarb; Vamidothion; XDE-105; XMC; Xylylcarb; Zeta-cypermethrin; ZXI 8901; the compound whose chemical name is 3-acetyl-5-amino-1-[2,6-dichloro-4-(trifluoromethyl)phenyl]-2-methylsulfinylpyrazole.

When present the one or more pesticides, may be included in any effective amount, and advantageously are present in amounts of from 5 ppm to 50,000 ppm, preferably 10 ppm to 10,000 ppm based on total weight of the plant treatment composition of which it forms a part, particularly in final end-use concentrations of the plant treatment compositions as applied to the plant.

Exemplary herbicides which may be used in the plant treatment compositions of the invention, may include one or more of: 2,3,6-TBA; 2,4-D; 2,4-D-2-ethylhexyl; 2,4-DB; 2,4-DB-butyl; 2,4-DB-dimethylammonium; 2,4-DB-isooctyl; 2,4-DB-potassium; 2,4-DB-sodium; 2,4-D-butotyl (2,4-D-Butotyl (2,4-D Butoxyethyl Ester)); 2,4-D-butyl; 2,4-D-dimethylammonium; 2,4-D-Diolamine; 2,4-D-isoctyl; 2,4-D-isopropyl; 2,4-D-sodium; 2,4-D-trolamine; Acetochlor; Acifluorfen; Acifluorfen-sodium; Aclonifen; Acrolein; AKH-7088; Alachlor; Alloxydim; Alloxydim-sodium; Ametryn; Amidosulfuron; Amitrole; ammonium sulfamate; Anilofos; Asulam; Asulam-sodium; Atrazine; Azafenidin; Azimsulfuron; Benazolin; Benazolin-ethyl; Benfluralin; Benfuresate; Benoxacor; Bensulfuron; Bensulfuron-methyl; Bensulide; Bentazone; Bentazone-sodium; Benofenap; Bifenox; Bilanofos; Bilanafos-sodium; Bispyribac-sodium; Borax; Bromacil; Bromobutide; Bromofenoxim; Bromoxynil; Bromoxynil-heptanoate; Bromoxynil-octanoate; Bromoxynil-potassium, Butachlor; Butamifos; Butralin; Butroxydim; butylate; Cafenstrole; Carbetamide; Carfentrazone-ethyl; Chlomethoxyfen; Chloramben; Chlorbromuron; Chloridazon; Chlorimuron; Chlorimuron-ethyl; Chloroacetic Acid; Chlorotoluron; Chlorpropham; Chlorsulfuron; Chlorthal; Chlorthal-dimethyl; Chlorthiamid; Cinmethylin; Cinosulfuron; Clethodim; Clodinafop; Clodinafop-Propargyl; Clomazone; Clomeprop; Clopyralid; Clopyralid-Olamine; Cloquintocet; Cloquintocet-Mexyl; Chloransulam-methyl; CPA; CPA-dimethylammonium; CPA-isoctyl; CPA-thioethyl; Cyanamide; Cyanazine; Cycloate; Cyclosulfamuron; Cycloxydim; Cyhalofop-butyl; Daimuron; Dalapon; Dalapon-sodium; Dazomet; Desmeduipham; Desmetryn; Dicamba; Dicamba-dimethylammonium; Dicamba-potassium; Dicamba-sodium; Dicamba-trolamine; Dichlobenil; Dichlormid; Dichlorprop; Dichlorprop-butotyl (Dichlorprop-butotyl (Dichlorpropbutoxyethyl ester)); Dichlorprop-dimethylammonium; Dichlorprop-isoctyl; Dichlorprop-P; Dichlorprop-potassium; Diclofop; Diclofop-methyl; Difenzoquat; Difenzoquat metilsulfate; Diflufenican; Diflufenzopyr (BAS 654 00 H); Dimefuron; Dimepiperate; Dimethachlor; Dimethametryn; Dimethenamid; Dimethipin; dimethylarsinic acid; Dinitramine; Dinoterb; Dinoterb acetate; Dinoterb-ammonium; Dinoterb-diolamine; Diphenamid; Diquat; Diquat dibromide; Dithiopyr; Diuron; DNOC; DSMA; Endothal; EPTC; Esprocarb; Ethalfluralin; Ethametsulfuron-methyl; Ethofumesate; Ethoxysulfuron; Etobenzanid; Fenchlorazole-ethyl; Fenclorim; Fenoxaprop-P; Fenoxaprop-P-ethyl; Fenuron; Fenuron-TCA; Ferrous Sulfate; Flamprop-M; Flamprop-M-Isopropyl; Flamprop-M-methyl; Flazasulfuron; Fluazifop; Fluazifop-butyl; Fluazifop-P; Fluazifop-P-butyl; Fluazolate; Fluchloralin; Flufenacet (BAS FOE 5043); Flumetsulam; Flumiclorac; Flumiclorac-Pentyl; Flumioxazin; Fluometuron; Fluoroglycofen; Fluoroglycofen-ethyl; Flupaxam; Flupoxam; Flupropanate; Flupropanate-sodium; Flupyrsulfuron-methyl-sodium; Flurazole; Flurenol; Flurenol-butyl; Fluridone; Fluorochloridone; Fluoroxypyr; Fluoroxypyr-2-Butoxy-1-methylethyl; Fluoroxypyr-methyl; Flurtamone; Fluthioacet-methyl; Fluxofenim; Fomesafen; Fomesafen-sodium; Fosamine; Fosamine-ammonium; Furilazole; Glyphosate; Glufosinate; Glufosinate-ammonium; Glyphosate-ammonium; Glyphosate-isopropylammonium; Glyphosate-sodium; Glyphosate-trimesium; Halosulfuron; Halosulfuron-methyl; Haloxyfop; Haloxyfop-P-methyl; Haloxyfop-etotyl; Haloxyfop-methyl; Hexazinone; Hilanafos; Imazacluin; Imazamethabenz; Imazamox; Imazapyr; Imazapyr-isopropylammonium; Imazaquin; Imazaquin-ammonium; Imazemethabenz-methyl; Imazethapyr; Imazethapyr-ammonium; Imazosulfuron; Imizapic (AC 263,222); Indanofan; Ioxynil; Ioxynil octanoate; Ioxynil-sodium; Isoproturon; Isouron; Isoxaben; Isoxaflutole; Lactofen; Laxynel octanoate; Laxynil-sodium; Lenacil; Linuron; MCPA; MCPA-butotyl; MCPA-dimethylammonium; MCPA-isoctyl; MCPA-potassium; MCPA-sodium; MCPA-thioethyl; MCPB; MCPB-ethyl; MCPB-sodium; Mecoprop; Mecoprop-P; Mefenacet; Mefenpyr-diethyl; Mefluidide; Mesulfuron-methyl; Metam; Metamitron; Metam-sodium; Metezachlor; Methabenzthiazuron; methyl isothiocyanate; methylarsonic acid; Methyldymron; Metobenzuron; Metobromuron; Metolachlor; Metosulam; Metoxuron; Metribuzin; Metsulfuron; Molinate; Monolinuron; MPB-sodium; MSMA; Napropamide; Naptalam; Naptalam-sodium; Neburon; Nicosulfuron; nonanoic acid; Norflurazon; oleic acid (fatty acids); Orbencarb; Oryzalin; Oxabetrinil; Oxadiargyl; Oxasulfuron; Oxodiazon; Oxyfluorfen; Paraquat; Paraquat Dichloride; Pebulate; Pendimethalin; Pentachlorophenol; Pentachlorophenyl Laurate; Pentanochlor; Pentoxazone; petroleum oils; Phenmedipham; Picloram; Picloram-potassium; Piperophos; Pretilachlor; Primisulfuron; Primisulfuron-methyl; Prodiamine; Prometon; Prometryn; Propachlor; Propanil; Propaquizafop; Propazine; Propham; Propisochlor; Propyzamide; Prosulfocarb; Prosulfuron; Pyraflufen-ethyl; Pyrazasulfuron; Pyrazolynate; Pyrazosulfuron-ethyl; Pyrazoxyfen; Pyribenzoxim; Pyributicarb; Pyridate; Pyriminobac-methyl; Pyrithiobac-sodium; Quinclorac; Quinmerac; Quinofolamine; Quizalofop; Quizalofop-ethyl; Quizalofop-P; Quizalofop-P-ethyl; Quizalofop-P-Tefuryl; Rimsulfuron; Sethoxydim; Siduron; Simazine; Simetryn; sodium chlorate; sodium chloroacetate; sodium pentachlorophenoxide; sodium-Dimethylarsinate; Sulcotrione; Sulfentrazone; Sulfometuron; Sulfometuron-methyl; Sulfosulfuron; Sulfuric acid; tars; TCA-sodium; Tebutam; Tebuthiuron; Tepraluxydim (BAS 6201); Terbacil; Terbumeton; Terbuthylazine; Terbutryn; Thenylchlor; Thiazopyr; Thifensulfuron; Thifensulfuron-methyl; Thiobencarb; Tiocarbazil; Tralkoxydim; triallate; Triasulfuron; Triaziflam; Tribenuron; Tribenuron-methyl; Tribenuron-methyl; trichloroacetic acid; Triclopyr; Triclopyr-butotyl; Triclopyr-triethylammonium; Trietazine; Trifluralin; Triflusulfuron; Triflusulfuron-methyl; Vernolate: YRC 2388.

When present the one or more herbicides, may be included in any effective amount, and advantageously are present in amounts of from 5 ppm to 50,000 ppm, preferably 10 ppm to 10,000 ppm based on total weight of the plant treatment composition of which it forms a part, particularly in final end-use concentrations of the plant treatment compositions as applied to the plant.

The composition of the invention may further contain one or more non-biologically active materials which include, but are not limited to one or more of: surfactants; solvents, e.g., non-aqueous solvents, safeners, binders, stabilizers, dyes, fragrances, pH buffers, pH adjusting agents, chelating agents, and lubricants according to the requirements of a particular plant treatment composition.

Non-limiting examples of surfactants useful in the plant treatment compositions of the invention include one or more of anionic, nonionic, cationic, amphoteric and zwitterionic surfactants, which can be used singly or in mixtures. Exemplary nonionic surfactants include polyoxyethylene alkyl ethers, polyoxyethylene alkyl allyl ethers, polyoxyethylene lanolin alcohols, polyoxyethylene alkyl phenol formalin condensates, polyoxyethylene sorbitan fatty acid esters, polyoxyethylene glycerol mono-fatty acid esters, polyoxypropylene glycol mono-fatty acid esters, polyoxyethylene sorbitol fatty acid esters, polyoxyethylene-castor oil derivatives, polyoxyethylene fatty acid esters, fatty acid glycerol esters, sorbitan fatty acid esters, sucrose fatty acid esters, polyoxyethylene polyoxypropylene block polymers, polyoxyethylene fatty acid amides, alkylol amides, and polyoxyethylene alkyl amines; aninonic surfactants include sodium salts of fatty acids such as sodium palmitate, ether sodium carboxylates such as polyoxyethylene lauryl ether sodium carboxylate, amino acid condensates of fatty acids such as lauroyl sodium sarcosine and N-lauroyl sodium glutamate, alkylarylsulfonates such as sodium dodecylbenzenesulfonate and diisopropylnaphthalenesulfonates, fatty acid ester sulfonates such as Laurie acid ester sulfonates, dialkyl sulfosuccinates such as dioctyl sulfosuccinate, fatty acid amidosulfonates such as oleic acid amidosulfonate, formalin condensates of alkylarylsulfonates, alcohol sulfates such as pentadecane-2-sulfate, polyoxyethylene alkyl ether sulfates such as polyoxyethylene dodecyl ether sodium sulfate, polyoxyethylene alkyl phosphates such as dipolyoxyethylene dodecyl ether phosphates, styrene-maleic acid copolymers, and alkyl vinyl ether-maleic acid copolymers; and amphoteric surfactants such as N-laurylalanine, N,N,N-trimethylaminopropionic acid, N,N,N-trihydroxye thylaminopropionic acid, N-hexyl N,N-dimethylaminoacetic acid, 1-(2-carboxyethyl)-pyridiniumbetaine, and lecithin; exemplary cationic surfactants include alkylamine hydrochlorides such as dodecylamine hydrochloride, benzethonium chloride, alkyltrimethylammoniums such as dodccyltrimethylammonium, alkyldimethylbenzylammoniums, alkylpyridiniums, alkylisoquinoliniums, dialkylmorpholiniums, and polyalkylvinylpyridiniums.

Non-limiting examples of solvents useful in the plant treatment compositions of the invention include one or more of saturated aliphatic hydrocarbons such as: decant, tridecane, tetradecane, hexadecane; and octadecane; unsaturated aliphatic hydrocarbons such as 1-undecene and 1-henicosene; halogenated hydrocarbons; ketones such as acetone and methyl ethyl ketone; alcohols such as methanol, ethanol, butanol, and octanol; esters such as ethyl acetate, dimethyl phthalate, methyl laurate, ethyl palmitate, octyl acetate, dioctyl succinate, and didecyl adipate; aromatic hydrocarbons such as xylene, ethylbenzene, octadecylbenzene, dodecylnaphthalene, tridecylnaphthalene; glycols, glycol esters, and glycol ethers such as ethylene glycol, diethylene glycol, propylene glycol monomethyl ether, and ethyl cellosolve; glycerol derivatives such as glycerol and glycerol fatty acid ester; fatty acids such as oleic acid, capric acid, and enanthic acid; polyglycols such as tetraethylene glycol, polyethylene glycol, and polypropylene glycol; amides such as N,N-dimethylformamide and diethylformamide: animal and vegetable oils such as olive oil, soybean oil, colza oil, castor oil, linseed oil, cottonseed oil, palm oil, avocado oil, and shark oil; as well as mineral oils. Water and blends of water with one or more of the foregoing organic solvents are also expressly contemplated as being useful solvent constituents.

Non-limiting examples of stabilizers which may be used in the invention are one or more of antioxidants, light stabilizers, ultraviolet stabilizers, radical scavengers, and peroxide decomposers. Examples of the antioxidant are antioxidants of phenol type, amine type, phosphorus type, and sulfur type antioxidants. Examples of the ultraviolet stabilizer are that of benzotriazole type, cyanoacrylate type, salicylic acid type, and hindered amine type. Isopropyl acid phosphate, liquid paraffin, and epoxidized vegetable oils like epoxidized soybean oil, linseed oil, and colza oil may also be used as the stabilizer.

Non-limiting examples of chelating agents which may be any of those known to those skilled in the art such as the ones selected from the group comprising phosphonate chelating agents, amino carboxylate chelating agents, other carboxylate chelating agents, polyfunctionally-substituted aromatic chelating agents, ethylenediamine N,N′-disuccinic acids, or mixtures thereof. Further suitable phosphonate chelating agents to be used herein may include alkali metal ethane 1-hydroxy diphosphonates (HEDP) also known as ethydronic acid, alkylene poly (alkylene phosphonate), as well as amino phosphonate compounds, including amino aminotri(methylene phosphonic acid) (ATMP), nitrilo trimethylene phosphonates.(NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP or ethydronic acid). Such phosphonate chelating agents are commercially under the trade name DEQUEST® (ex. Degussa). Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene. An exemplary and preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins.

Further suitable chelating agents include amino carboxylates including include ethylene diamine tetra acetates, diethylene triamine pentaacetates, diethylene triamine pentaacctate (DTPA), N-hydroxyethylethylenediamine triacetates, nitrilotri-acetates, ethylenediamine tetrapropionatcs, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA). Yet further useful chelating agents include carboxylate chelating such as salicylic acid, aspartic acid, glutamic acid, glycine, malonic acid or mixtures thereof. Such one or more chelating agents may be included in acceptable amounts.

The plant treatment compositions may include one or more pH adjusting agents and/or pH buffers. Essentially an material which may be used to adjust the pH of the plant treatment compositions are considered suitable, non-limiting examples of which include one or more of inorganic acids, organic acids, bases, alkaline materials, hydroxides, hydroxide generators, a buffer, as well as mixtures thereof.

Also suitable as pH-adjusting agents are monoethanolamine compounds, such as diethanolamine and triethanolamine, and beta-aminoalkanol compounds, particularly beta-aminoalkanols having a primary hydroxyl group, and a mixture thereof. Further nonlimiting examples of pH-adjusting agents include alkali metal salts of various inorganic acids, such as alkali metal phosphates, polyphosphates, pyrophosphates, triphosphates, tetraphosphates, silicates, metasilicates, polysilicates, borates, carbonates, bicarbonates, hydroxides, and mixtures of same. It may also be suitable to use buffers such materials as aluminosilicates (zeolites), borates, aluminates and certain organic materials such as gluconates, succinates, maleates, citrates, and their alkali metal salts. A preferred pH-adjusting agent is an alkali metal hydroxide. Such buffers keep the pH ranges of the compositions of the present invention within acceptable limits.

Each of the foregoing non-biologically active materials which may be individually included in effective amounts. The total amounts of the one or more non-biologically active materials may be as little as 0.001% wt., to as much as 99.999% wt., based on the total weight of the plant treatment composition of which said non-biologically active materials form a part, particularly in final end-use concentrations of the plant treatment compositions as applied to the plant.

Preferred biologically and non-biologically active materials which are preferred are those which are based on metal salts, which metals which may be complexed or bound to the alginates, as it is believed that such would form complexes which are potentially better retained.

The plant treatment compositions can be advantageously applied against a broad range of diseases in different crops. They may be applied as leaf, stem, root, into-water, seed dressing, nursery box or soil treatment compositions. Thus the plant treatment compositions of the invention can be applied to the seed, soil, pre-emergence, as well as post-emergence such as directly onto immature or mature plants. The plant treatment compositions of the invention can be applied according to conventional application techniques known to the art, including electrodynamic spraying techniques. It is hypothesized that at least the metal alginate salts are deposited and are retained on the plant matter surfaces after the carrier, viz., aqueous medium or aqueous organic solvent medium has evaporated.

The plant treatment compositions are believed to have broad applicability to pathogentic fungi and bacteria and other diseases in said plants and particularly food crops.

The plant treatment compositions are believed to have particular activity against pathogentic fungi, bacteria or other diseases in plants which are characterized to be resistant to copper or other metals, especially copper.

Citrus crop diseases which may be treated by the plant treatment compositions of the invention include: algal spot, melanose, scab, greasy spot, pink pitting, alternaria brown spot, phytophthora brown rot, sptoria spot, phytophthora foot rot, and citrus canker.

Field crop diseases which are treatable by the plant treatment compositions of the invention include: for alfalfa, cercospora leaf spot, leptosphaerulina leaf spot; for corn, bacteria stalk rot; for peanut, cercospora leaf spot; for potato and other tubers, early blight, late blight; for sugar beet, cercospora leaf spot, and for wheat, barley and oats, helminthosporium spot blotch, septoria leaf blotch.

Diseases of small fruits which are treatable by the plant treatment compositions of the invention include: for blackberry (including Aurora, Boysen, Cascade, Chehalem, Logan, Marion, Santiam, and Thornless Evergreen varietals), anthracnose, cane spot, leaf spot, pseudomonas blight, purple blotch, yellow rust; for blueberry, bacterial canker, fruit rot, phomopsis twig blight; for cranberry, fruit rot, rose bloom, bacterial stem canker, leaf blight, red leaf spot, stern blight, tip blight (monilinia); for currants and gooseberry, anthracnose, leaf Spot; for raspberry, anthracnose, cane spot, leaf spot, pseudomonas, blight, purple blotch, yellow rust; for strawberry, angular leaf spot (xanthomonas), leaf blight, leaf scorch, leaf spot.

Diseases of tree crops which are treatable by the plant treatment compositions of the invention include: in almond, apricot, cherry, plum; and prune trees and crops, bacterial blast (Pseudomonas), bacterial canker, coryneum blight (shot hole), blossom brown rot, black knot, cherry leaf spot; in apple trees and crops; anthracnose, blossom blast, european canker (nectria), shoot blast (Pseudomonas), apple scab, fire blight, collar root, crown rot; in avocado trees and crops, anthracnose, blotch, scab; in banana trees and crops, sigatoka (black and yellow types), black pitting; in cacao trees and crops, black pod, in coffee plants and crops, coffee berry disease (Collectotrichum coffeanum), bacterial blight (Pseudomonas syringae), leaf rust (Hemileia vastatrix), iron spot (Cercospora coffeicola), pink disease (Corticium salmonicolor); in filbert trees and crops, bacterial blight, eastern filbert blight, in mango trees and crops, anthracnose, in olive trees and crops, olive knot, peacock spot; in peach and nectarine trees and crops, bacterial blast (Pseudomonas), bacterial canker, bacterial spot (Xanthomonas), coryneum blight (shot dole), leaf curl, bacterial spot; in pear trees and crops, fire blight and blossom blast (Pseudomonas); in pecan trees and crops, kernel rot, shuck rot, (Phytophthora cactorum), zonate leaf spot (Cristulariella pyramidalis), ball moss, Spanish moss; in pistachio trees and crops, botryosphaeria panicle and shoot blight, botrytis blight, late blight (Alternaria alternate), septoria leaf blight; in quince trees and crops, fire blight, and in walnut trees and crops, walnut blight.

Diseases of small fruits which are treatable by the plant treatment compositions of the invention include: in green beans, brown spot, common blight, halo blight, in beets including table beets and beet greens, cercospora leaf spot; in carrots, alternaria leaf spot, cercospora leaf spot; in celery, celeriac, bacterial blight, cercospora early blight, septoria late blight; in crucifers such as broccoli, brussels sprout, cabbage, cauliflower, collard greens, mustard greens, and turnip greens, black leaf spot (Alternaria), black rot (Xanthomonas), downy mildew; in cucurbits such as cantaloupe, cucumber, honeydew, muskmelon, pumpkin, squash, watermelon, alternaria leaf spot, angular leaf spot, anthracnose, downy mildew, gummy stem blight, powdery mildew, watermelon bacterial fruit blotch; in eggplant, alternaria blight, anthracnose, phomopsis; in okra, anthracnose, bacterial leaf spot, leaf spots, pod spot, powdery mildew; in onions and garlic, bacterial blight, downy mildew, purple blotch; in peas, powdery mildew; in peppers, anthracnose, bacterial spot, cercospora leaf spot; in spinach, anthracnose, blue mold, cercospora leaf spot, white rust, in tomato, anthracnose, bacterial speck, bacterial spot, early blight, gray leaf mold, late blight, septoria leaf spot, and in watercress, cercospora, leaf spot.

Diseases of vines and fruits which are treatable by the plant treatment compositions of the invention include: in grapes, black rot, downy mildew, phomopsis, powdery mildew; in hops, downy mildew; in kiwi, Erwinia herbicola; Pseudomonas fluorescens, Pseudomonas syringae

The following further crops and diseases which are treatable by the plant treatment compositions of the invention include: in atemoya, anthracnose; in carambola, anthracnose; in chives, downy mildew; in dill, phoma leaf spot, rhizoctonia foliage blight; in ginseng, alternaria leaf blight, stem blight; in guava, anthracnose, red algae; in macadamia, anthracnose, phytophthora blight (P. capsici), raceme blight (Botrytis cinerea); in papaya, anthracnose; in parsley, bacterial blight (Pseudomonas sp.); in passion fruit, anthracnose; in sugar apple (Annona), Anthracnose, and in sycamore, Anthracnose.

Specific diseases of greenhouse and shadehouse crops which are treatable by the plant treatment compositions of the invention include: in non-bearing citrus plants, brown rot, citrus canker, greasy spot, melanose, pink pitting, scab; in cucumbers, angular leaf spot, downy mildew; in eggplant, alternaria blight, anthracnose; in tomato, anthracnose, bacterial speck, bacterial spot, early blight, gray leaf mold, late blight, septoria leaf spot.

Specific diseases of confiers which are treatable by the plant treatment compositions of the invention include: in Douglas fir, Rhabdocline Needlecast, in firs, needlecasts, in juniper, Antracnose, Phomopsis Twig Dieback, in Leyland cypress, Cercospora Needle Blight, in pine, needlecasts and in spruce, needlecasts.

The plant treatment compositions may be provided in a variety of product forms. In one such form a concentrated composition containing the metal alginate salts are provided in a form wherein the concentrated composition is intended to be blended or dispersed in a further fluid carrier such as water or other largely aqueous liquid, either without further biologically active materials or conjointly with one or more further biologically active materials, e.g., materials which exhibit or provide pesticidal, disease control, including fungicidal, mildew control or herbicidal or plant growth regulating effects, as well as any other further desired biologically inactive constituents which are recognized as being a useful in the art. In a further product form, the plant treatment compositions of the invention are provided as a ready to use product wherein the metal alginate salts are provided in the said composition at a concentration which requires no further dilution but can be directly applied to plants, or crops, viz., as a ready to use composition. In a still further product form, the metal alginate salts are provided in conjunction with one or more further biologically active materials, e.g., materials which exhibit or provide pesticidal, disease control, including fungicidal, mildew control or herbicidal or plant growth regulating effects, as well as any other further desired biologically inactive constituents, in the form of a premix, or in the form of a concentrate which is intended to be added to further the carrier medium, such as an aqueous liquid which may, or may not include further constituents already present therein.

The plant treatment composition may also be provided in a powdered or solid form, e.g., a comminuted solid which can be dispersed into a fluid carrier or medium, in a concentrated form, which may be a solid, liquid, or a gel which is intended to be further dissolved or dispersed in a carrier medium, such as a liquid which may be pressurized or non-pressurized, e.g., water. Such a plant treatment composition is advantageously and conveniently provided as a dispersible or dilutable concentrate composition which is then used in a “tank mix” which may optionally include further compositions or compounds, including but not limited to biologically active materials and non-biologically active materials.

The plant treatment compositions of the invention may also be provided in any suitable or conventional packaging means. For example, conventional containers such as bottles, or sachets containing a solid, liquid or fluid composition enclosed within a water-soluble film may be conveniently provided particularly when the former are provided in premeasured unit dosage forms. The latter are particularly useful in avoiding the need for measuring or packaging and provides a convenient means whereby specific doses that the plant treatment compositions can be provided.

The following examples further illustrate the present invention. It should be understood, however, that the invention is not limited solely to the particular examples given below.

### EXAMPLES

Plant treatment compositions according to the invention were produced and are identified as indicated following, wherein the amount of the indicated constituent is represented as parts by weight based on the total weight of the composition of which it formed a part. Additionally the amount of Cu(II) was calculated and indicated as parts per million for each of the following formulae.

TABLE 1

| | E1 | E2 | E3 |
|---|---|---|---|
| | (wt %) | (wt %) | (wt %) |
| copper sulfate | 12.90 | 0.59 | 8.27 |
| pentahydrate | | | |
| Manugel ® GMB | — | 1.58 | 0.84 |
| Manugel ® LBA | 3.22 | — | — |
| ammonia solution | 15.48 | 0.87 | 12.10 |
| sodium citrate | 12.90 | 1.00 | 18.96 |
| ammonium sulfate | 12.90 | — | 18.80 |
| ammonium carbonate | — | — | — |
| DI water | 42.58 | 95.95 | 40.92 |
| pH | 9.2 | 9.98 | 9.05 |
| Cu(II), ppm | 32840 | 1515 | 21068 |

The identity of the specific constituents indicated on Table 1 (as well as in the examples described later) are described with more specificity on the following Table 2:

TABLE 2

| | |
|---|---|
| copper sulfate pentahydrate | anhydrous copper sulfate pentahydrate |
| Manugel ® GMB | alginate, having an approx. molecular weight |
| | of 80,000-120,000 (ex. FMC) |
| Manugel ® LBA | alginate, having an approximate molecular |
| | weight of about 18,000 (ex. FMC) |
| ammonia solution | aqueous solution containing 30% wt. of NH₃ |
| sodium citrate | anhydrous sodium citrate |
| ammonium sulfate | anhydrous ammonium sulfate |
| ammonium carbonate | anhydrous ammonium carbonate |
| DI water | deionized water |

The compositions of Table 1 were produced in accordance with the following general protocol.

Measured amounts of deionized water at room temperature (approx. 20° C.) was provided to a suitable mixing vessel, to which were subsequently added during mixing of the contents of the mixing vessel in the following sequence, copper sulfate pentahydrate, when present, citrates, e.g., ammonium citrate and sodium citrate, and ammonium sulfate (which may alternately have been provided as an aqueous ammonia solution as indicated on Table 2) Mixing continued until all added constituents were dissolved and the aqueous composition was uniform. Subsequently the alginate constituent was slowly added during stirring until the alginate was dissolved in the aqueous composition which was present in the mixing vessel, and subsequently the formed plant treatment composition was withdrawn.

The composition E1 of Table 1 was subjected to various further tests in order to evaluate the stability of the composition.

Two samples of E1 were placed in an oven at 54° C. One was removed after one week, while the other sample was removed after two weeks. The samples were tested for suspensibility, foam, pH, viscosity, and wet sieve retention.

Viscosities were measured using a Brookfield viscometer equipped with spindle number 62 at 100 rpm. Suspensibility was determined gravimetrically by measuring total % solids of the initial diluted solutions and that of the bottom 10% after a ½ hour settling time. The results are given in the following tables. Sedimentation was tested as no sediment is believed to form in the composition. The results are reported on the following Table 3.

TABLE 3

| | Viscosity of | | % Retained | % Retained |
|---|---|---|---|---|
| | Concentrate | pH of | on 100 | on 325 |
| E1 | (cp) | Concentrate | Mesh Screen | Mesh Screen |
| 0 Weeks Old | 91.8 | 9.83 | 0.04 | 0.05 |
| 1 Week Old | 195.3 | 9.78 | 0.05 | 0.05 |
| 2 Weeks Old | 389.5 | 9.80 | 0.14 | 0.19 |

The following table refers to testing performed on the samples diluted to 500 ppm in hard water.

TABLE 4

| | | Dilution | | | | |
|---|---|---|---|---|---|---|
| | Temp | Water | | Viscosity | | |
| E1 | (° C.) | Hardness | pH | (cp) | Foam | Suspensibility |
| 1 Week Old | 25 | 342 | 9.13 | ~1 | None | 97.62 |
| 1 Week Old | 0 | 342 | 9.52 | ~1 | None | 97.15 |
| 1 Week Old | 25 | 1000 | 9.05 | ~1 | None | 97.11 |
| 1 Week Old | 0 | 1000 | 9.5 | ~1 | None | 98.26 |
| 2 Week Old | 25 | 342 | 9.14 | ~1 | None | 99.15 |
| 2 Week Old | 0 | 342 | 9.56 | ~1 | None | 99.93 |
| 2 Week Old | 25 | 1000 | 9.10 | ~1 | None | 98.88 |
| 2 Week Old | 0 | 1000 | 9.49 | ~1 | None | 95.29 |

Three samples of E1 were placed in a freezer held at 0° F. and left overnight. The next day, the samples were removed and allowed to thaw and equilibrate to room temperature. Upon thawing, they resumed their usual appearance—no clumping, precipitation, or other unusual behavior. The viscosity of one of them was measured and the other two were placed back in the freezer. The cycle was repeated until the last sample had been frozen three times. The Table 5 below summarizes the viscosity measurements.

TABLE 5

| Cycle # | Viscosity (cp) |
|---|---|
| 1 | 92.4 |
| 2 | 97.8 |
| 3 | 76.5 |

Further examples of formulation of a plant treatment compositions falling within the scope of the invention are demonstrated by the following further examples.

### Example E4

The following were blended together in a 1 liter beaker using magnetic stirring.

| | Mass | Wt % of Final |
|---|---|---|
| Material | (grams) | Mixture |
| DI water | 844.8 | 99.58 |
| ammonium carbonate | 1.09 | 0.13 |
| copper sulfate | 1 | 0.12 |
| 30% ammonia Solution | 1.2 | .014 |

Then, 0.25 grams (0.03% of the total) of Manugel LBA were added and the mixture was stirred until homogeneous. In addition to the ammonia solution, further ammonia was formed by the in situ reaction of ammonium carbonate in water and thus provided to the composition. The resulting copper concentration (Cu (II)) was 300 parts per million by weight and the pH was 9.14.

### Example E5

The following were blended together in a 1 liter beaker using magnetic stirring:

| | Mass | Wt % of Final |
|---|---|---|
| Material | (grams) | Mixture |
| DI water | 845.6 | 99.68 |
| ammonium carbonate | 1.5 | 0.18 |
| copper sulfate | 1 | 0.12 |

Then, 0.25 grams (0.03% of the total) of Manugel LBA were added and the mixture was stirred until homogeneous. Ammonia was formed by the in situ reaction of ammonium carbonate in water. The resulting copper concentration was 300 parts per million by weight and the pH was 8.94.

### Example E6

The following were blended together in a 1 liter beaker using magnetic stirring:

| | Mass | Wt % of Final |
|---|---|---|
| Material | (grams) | Mixture |
| DI water | 844.7 | 99.51 |
| ammonium acetate | 1.75 | 0.21 |
| copper sulfate | 1 | 0.12 |
| 30% ammonia solution | 1.2 | 0.14 |

Then, 0.25 grams (0.03% of the total) of Manugel LBA were added and the mixture was stirred until homogeneous. The resulting copper concentration was 300 parts per million by weight and the pH was 8.53.

### Example E7

The following were blended together in a 1 liter beaker using magnetic stirring.

| | Mass | Wt % of Final |
|---|---|---|
| Material | (grams) | Mixture |
| DI water | 840 | 99.71 |
| copper sulfate | 1 | 0.12 |
| 30% ammonia solution | 1.2 | 0.14 |

Then, 0.25 grams (0.03% of the total) of Manugel LBA were added and the mixture was stirred until homogeneous. Finally, carbon dioxide was bubbled up through the mixture until the pH was 7.48. As the pH change was almost instantaneous upon contact with carbon dioxide, the actual mass of carbon dioxide in the formula is assumed to be negligible. The resulting copper concentration was approximately 302 parts per million by weight.

### Example E8

The following were blended together in a 1 liter beaker using magnetic stirring.

| | Mass | |
|---|---|---|
| Material | (grams) | Wt % of Final Mixture |
| DI water | 844.7 | 99.71 |
| copper sulfate | 1 | 0.12 |
| 30% ammonia solution | 1.2 | 0.14 |

Then, 0.25 grams (0.03% of the total) of Manugel LBA were added and the mixture was stirred until homogeneous. Finally, the pH of the mixture was adjusted to 8.53 using citric acid. The copper concentration was approximately 302 parts per million by weight.

While the foregoing illustrate useful formulations of various plant treatment compositions in either concentrated forms, as well as in “ready to use” forms, it is nonetheless to be understood that the compositions of the invention may include metallic alginate salts based on metals other than copper. Further, the actual concentration of the sodium alginate and the copper sulfate can be different than those given above, and may be any which is found to be effective in order to provide a metal salt alginate as an end product. These amounts can be determined by routine experimental methods. It is expressly contemplated that the compositions may be further varied, e.g, the use of alginates having lesser or greater molecular weights; the use of alginates of two or more different types or molecular weights; the use of other metal salts other than copper, as well the use of a plurality of different metal salts, and yet fall within the teaching of the present invention. It is further expressly contemplated that certain of the example compositions, e.g. composition E1, may be diluted or dispersed in a larger volume of a carrier solvent, e.g., water, and optionally one or more further optional constituents, e.g., buffers, chealants, surfactants, organic solvents, and thereafter applied to a plant, plant part, or crop.

### (B) Field Trials

### (B.1) Control of Citrus Bacterial Canker on Grapefruit

Duncan grapefruit plants (seedlings) were cut back to encourage new plant growth susceptible to the citrus canker bacterium. Once the foliage had grown out and were susceptible to inoculation, the plants were sprayed with an aqueous dilution of the E1 composition of Table 1 as indicated in the following Table 6 to runoff to ensure good coverage of the leaves. Thereafter, the plants were inoculated with an aqueous bacterial culture of the citrus canker bacterium, (Xanthomonas axonopodis pv. citri), adjusted to contain 1×10⁸ colony forming units (“CFU”) per ml. The plants were inoculated by spraying them to runoff with the said aqueous bacterial culture, after which the individual plants were sealed in polyethylene bags for 40 hours and retained in a greenhouse, after which the bags were removed. Approximately 40 days following the initial treatment followed by inoculation, the intensity of the bacterial spots at disease caused by the citrus canker bacterium was estimated by observing the percent of the leaf area affected by the bacterial spots. These were compared to a control grapefruit plant which had not been treated with a composition from Table 6, but which had only been inoculated with the aqueous bacterial culture of the citrus canker bacterium. The rating evaluations were based on a randomized complete block design; multiple replicates of grapefruit plants for each of the compositions from Table 6 were evaluated. Disease ratings are based on the Horsfall-Barret scale, wherein a rating of: 1 indicated 0% defoliation, 2 indicated 0-3% defoliation, 3 indicated 3-6% defoliation, 4 indicated 6-12% defoliation, 5 indicated 12-25% defoliation, 6 indicated 25-50% defoliation, and up to a rating of 12 indicating 100% defoliation. Two comparative compositions based on commercially available copper containing compositions, “Kocide 2000” (ex. DuPont) and “Cuprofix Ultra 40” described to comprise 71.1% wt. copper sulfate, equivalent to 40% metallic copper, and the balance being other unspecified ingredients (ex. Cerexagri-Nisso LLC, King of Prussia, Pa.), were applied at the application rates indicated on Table 6 as well, and compared to both plants treated with aqueous dilutions of E1, as well as to the untreated but inoculated control grapefruit plants.

TABLE 6

| | Application Rate of | |
|---|---|---|
| | Treatment Composition - | |
| Treatment Composition | (Cu) | Disease ratings |
| T1 - aqueous dilution of E1 | 45 ppm | 1.5 |
| T2 - aqueous dilution of E1 | 90 ppm | 2 |
| T3 - aqueous dilution of E1 | 154 ppm | 1.5 |
| T4 - aqueous dilution of E1 | 309 ppm | 1 |
| T5 - aqueous dilution of E1 | 3830 ppm | — |
| C1 - Kocide 2000 | 3830 ppm | 1.5 |
| C2 - Cuprofix Ultra 40 | 3830 ppm | 1.5 |
| Control | — | 3.7 |

“Application Rate of Treatment Composition - (Cu)” refers to the concentration of Cu(II) ions as indicated for the Treatment Composition

Of the above results, the T5 composition was not rated as extensive tissue death was observed in the treated grapefruit plants. The commercially available products provided approximately tenfold amounts of available copper in order to obtain comparative degrees of control provided by the T1 to T4 compositions.

### (B.2) Control of Citrus Bacterial Canker on Swingle Orange

In a greenhouse, Swingle orange plants (seedlings) (Citrus sinensis) in 1 gallon pots were cut back to encourage new plant growth susceptible to the citrus canker bacterium. Once the foliage had grown out and were susceptible to inoculation, the plants were sprayed using a handheld aerosol canister to runoff to ensure good coverage of the leaves with varying aqueous dilutions of the E1 composition of Table 1 as indicated in the following Table 7. Four plants were used as replicates per dilution of E1 tested. On the next day, these treated plants were inoculated with an aqueous bacterial culture of the citrus canker bacterium, (Xanthomonas axonopodis pv. citri), adjusted to contain 1×10⁸ colony forming units (“CFU”) per ml. The plants were inoculated by spraying them to runoff with the said aqueous bacterial culture, after which the individual plants were allowed to stand in the greenhouse. Subsequently, 22 days after this initial inoculation, the intensity of the bacterial spots caused by the citrus canker bacterium was estimated by observing the percent of the leaf area affected by the bacterial spots. These were compared to a control grapefruit plant which had not been treated with a composition from Table 7, but which had only been inoculated with the aqueous bacterial culture of the citrus canker bacterium, as well as with plants treated with compositions of “Kocide 2000” (ex. DuPont) and “Cuprofix Ultra 40” which were used as comparative examples. Subsequently, at 34 days after the first treatment, the plants were again treated with the varying aqueous dilutions of the E1 composition of Table 1 as indicated in the following Table 7, and on the next day, the plants were again inoculated with an aqueous bacterial culture of the citrus canker bacterium, (Xanthomonas axonopodis pv. citri), adjusted to contain 1×10⁸ colony forming units (“CFU”) per ml. as described above, and again the treated and inoculated plants were allowed to stand in the greenhouse. All plants were evaluated at 62 days, and 69 days after the initial inoculation for the intensity of the bacterial spots caused by the citrus canker bacterium which was estimated by observing the percent of the leaf area affected by the bacterial spots. The results are reported on Table 7, following. The rating evaluations were based on a randomized complete block design; multiple replicates of the orange plants for each of the compositions from Table 7 were evaluated. Disease ratings are based on the Horsfall-Barret scale, wherein a rating of: 1 indicated 0% defoliation, 2 indicated 0-3% defoliation, 3 indicated 3-6% defoliation, 4 indicated 6-12% defoliation, 5 indicated 12-25% defoliation, 6 indicated 25-50% defoliation, and up to a rating of 12 indicating 100% defoliation.

TABLE 7

| | Application | Application | | | |
|---|---|---|---|---|---|
| | Rate of | Rate of | Disease ratings, at days | | |
| | Treatment | Treatment | post initial inoculation | | |
| Treatment | Composition | Composition - | 34 | | |
| Composition | onto Plant | (Cu) | days | 62 days | 69 days |
| T6 - aqueous | 1.1 ml/Litre | 35 ppm | 2.3 | 2.1 | 3.9 |
| dilution of E1 | water | | | | |
| T7 - aqueous | 2.2 ml/Litre | 70 ppm | 2.7 | 2.3 | 3.9 |
| dilution of E1 | water | | | | |
| T8 - aqueous | 3.7 ml/Litre | 118 ppm | 2.4 | 2.5 | 3.1 |
| dilution of E1 | water | | | | |
| T9 - aqueous | 7.5 ml/Litre | 240 ppm | 1.6 | 2.4 | 2.7 |
| dilution of E1 | water | | | | |
| T10 - aqueous | 85.6 ml/Litre | 2740 ppm | 2.1 | 1.2 | 1.2 |
| dilution of E1 | water | | | | |
| C3 - Kocide | diluted, as | 3815 ppm | 2.4 | 1.6 | 2.4 |
| 2000 | supplied to | | | | |
| | 10.9 g/Litre | | | | |
| | water | | | | |
| C4 - Cuprofix | diluted, as | 3840 ppm | 2.5 | 1.9 | 2.1 |
| Ultra 40 | supplied to | | | | |
| | 9.6 g/Litre | | | | |
| | water | | | | |
| Control | — | — | 3.2 | 4.8 | 5.1 |

“Application Rate of Treatment Composition - (Cu)” refers to the concentration of Cu(II) ions as indicated for the Treatment Composition

The above results demonstrate the excellent efficacy of the treatment compositions of the invention compared to the commercial products.

### (B.3) Control of Citrus Bacterial Canker on Walnuts

The efficacy of the inventive compositions, as well as compositions of a commercial product, “Cuprofix Ultra 40” in controlling walnut blight (Xanthomonas arboricola pv juglandis) was evaluated. A series of walnut trees in an existing orchard (variety: Juglans regia, e.g., “common walnut”) were tested by successively spraying the trees with one of the several compositions indicated on Table 8. The average age of the trees was 20 years. Four trees were used as replicates for testing the efficacy of a specific compositions, and these were compared to a four untreated trees which were used as a control sample, as well as a further set of four trees which were treated with a dilution of the “Cuprofix Ultra 40” which was used as supplied from the manufacturer and diluted in water which was used as a comparative example. The compositions were applied by spraying the leaves of each tree using a Solomist-type sprayer, with ⅛ inch nozzles which were applied at a rate of 100 gallons/acre. The trees of the respective set of replicates were initially treated with the compositions of Table 8, as well as retreated at 11 days, 29 days and 37 days following the initial treatment. The incidence of disease was evaluated by a trained observer, at 59 days psi 93 days following the initial treatment who indicated each of the % of infected leaves per tree, the number of infected flowers per tree, as well as the severity of the disease which was observed by reviewing the leaves of the tree, with a value of “0” indicating no infection, and a value of “10” indicating total infection. The ratings were based on the average from each of the 4 trees per replicate set which was treated with a specific composition.

TABLE 8

| | | | Disease incidence | | | | | |
|---|---|---|---|---|---|---|---|---|
| | Application Rate | Application Rate | (% infected | | Number of infected | | Disease Severity | |
| Treatment | of Treatment | of Treatment | leaves/tree) | | flowers per tree | | (leaf infection) | |
| Composition | Composition | Composition - (Cu) | 59 days | 93 days | 59 days | 93 days | 59 days | 93 days |
| T11 - aqueous | 32 oz. E1/100 | 80 ppm | 4.8 | 7 | 5.8 | 5.2 | 3.4 | 3.0 |
| dilution of E1 | gal water | | | | | | | |
| T12 - aqueous | 64 oz. E1/100 | 160 ppm | 5.4 | 8.2 | 5.4 | 1.6 | 3.0 | 3.2 |
| dilution of E1 | gal water | | | | | | | |
| T13 - aqueous | 96 oz. E1/100 | 240 ppm | 5.9 | 10 | 7.6 | 6.2 | 4.6 | 3.6 |
| dilution of E1 | gal water | | | | | | | |
| T14 - aqueous | 128 oz. E1/100 | 320 ppm | 7.6 | 12.8 | 5.8 | 2.0 | 4.4 | 3.6 |
| dilution of E1 | gal water | | | | | | | |
| Cuprofix | 8 lbs./100 gal | 3750 ppm | 5.4 | 5.8 | 3.2 | 1.0 | 3.2 | 3.0 |
| Ultra 40 | water | | | | | | | |
| Untreated | — | — | 15.2 | 19.4 | 14.8 | 18.2 | 4.4 | 4.0 |
| control | | | | | | | | |

“Application Rate of Treatment Composition - (Cu)” refers to the concentration of Cu(II) ions as indicated for the Treatment Composition

As evident from the foregoing, the inventive compositions exhibited excellent control of the walnut blight, notwithstanding low levels of copper (Cu (II)) as compared to the commercial product.

### (B.4) Control of Fire Blight on Apples and Pear Trees

The efficacy of the inventive compositions, as well as compositions of a commercial product, “Kocide 3000” in controlling fire blight (Xanthomonas arboricola pv juglandis) was evaluated. Each of a series of apple trees (apple variety: Red Delicious) approximately 20 years old, and pear trees (pear variety: D'Anjou) approximately 25 years old in existing orchards were used for the test. The trees were inoculated with a bacterial “Fire Blight” pathogen (Erwinia amylovora, strain Ea. 153al) which was isolated in Oregon (U.S.A.) which was cultivated on a nutrient agar, and then diluted to provide a concentration of about 1 million colony forming units (“CFU”) per ml of water, viz., the inoculant. Inoculation was performed by spraying the inoculant using a non-pressurized trigger-pump sprayer to mist the inoculant onto about 100 blossom clusters per replicate (tree) to ensure that the blossoms were fully wetted but not to the point of dripping. Both the pear and apple trees were first sprayed with a tested composition of Table 9 on a day of which approximately 80% of the blossoms were in bloom, inoculated with the inoculant as described above on the next day, and on the next following day, the trees were again sprayed with a respective test composition. The test compositions were sprayed using a backpack sprayer operating at an application rate of approximately 100 gallons per acre of a tested treatment composition. The test also included a comparative sample, “Kocide 3000” (ex. DuPont) which was diluted in water and applied as the test compositions.

Following treatment, the treated trees were periodically evaluated for approximately 7 weeks, and the number of blighted blossom clusters were noted and indicated as a percentage relative to the initial inoculated blossom clusters. It was concurrently observed that there were no naturally occurring infections in the non-inoculated trees in the area during the test. The observed results are also reported on Table 9. The ratings were based on the average from each of the 4 trees per replicate set which was treated with a specific treatment composition. Roth the percent of infection (“% infection”) among the blossoms, and the relative degree of control (“% control”) relative to the inoculated but untreated control replicates are reported.

TABLE 9

| | | | |
|---|---|---|---|
| | Application Rate of | | |
| | Treatment | % | % |
| Treatment Composition | Composition - (Cu) | infection | control |

Apples

| | | | | |
|---|---|---|---|---|
| T15 - aqueous dilution of E1 | 320 | ppm | 2.7 | 95.5 |
| of 4 quarts per 100 gallons | | | | |
| T16 - aqueous dilution of E1 | 160 | ppm | 4.6 | 92.4 |
| of 2 quarts per 100 gallons | | | | |
| T17 - aqueous dilution of E1 | 80 | ppm | 33.7 | 44.2 |
| of 1 quart per 100 gallons | | | | |
| C3 - Kocide 3000 diluted at | 175 | | 23.5 | 61.1 |
| 0.5 lbs per 100 gallons | | | | |

| | | | |
|---|---|---|---|
| Control - inoculated, | — | 64.4 | 0 |
| untreated | | | |
| Control - uninoculated, | — | 0 | 0 |
| untreated | | | |

Pears

| | | | | |
|---|---|---|---|---|
| T15 - aqueous dilution of E1 | 320 | ppm | 1 | 98.4 |
| of 4 quarts per 100 gallons | | | | |
| T16 - aqueous dilution of E1 | 160 | ppm | 8 | 87.6 |
| of 2 quarts per 100 gallons | | | | |
| T17 - aqueous dilution of E1 | 80 | ppm | 30.1 | 53.3 |
| of 1 quart per 100 gallons | | | | |
| C3 - Kocide 3000 diluted at | 175 | ppm | 28.2 | 56.3 |
| 0.5 lbs per 100 gallons | | | | |

| | | | |
|---|---|---|---|
| Control - inoculated, | — | 64.5 | 0 |
| untreated | | | |
| Control - uninoculated, | — | 0 | 0 |
| untreated | | | |

“Application Rate of Treatment Composition - (Cu)” refers to the concentration of Cu(II) ions as indicated for the Treatment Composition

1. Plant treatment compositions useful in the treatment of plants, comprising metal alginate salts and at least one amine compound and/or ammonia as compositions useful in the treatment of plants.

2. Plant treatment compositions according to claim 1 comprising Cu(II) salts of alginic acid.

3. Plant treatment compositions according to claim 1 comprising Ag(II) salts of alginic acid.

4. Plant treatment compositions according to claim 1, wherein the amine compound is selected from the group consisting of: ammonia, a primary amine, a secondary amine and a tertiary amine compound.

5. Plant treatment compositions according to claim 4 wherein the amine compound comprises ammonia.

6. Plant treatment compositions according to claim 1, wherein the said compositions exclude other biologically active materials which exhibit or provide pesticidal, disease control, including fungicidal, mildew control or herbicidal or plant growth regulating effects.

7. Methods for the production of plant treatment compositions according to claim 1, the method comprising the step of reacting a metal, an inorganic and/or organic compound or species which releases a suitable metal ion, with an alginate in order to form a metal alginate salt.

8. A method for the treatment of plants, including food crops in order to control the incidence of and/or spread of pathogentic fungi and bacteria and other diseases in said plants and particularly food crops and providing improved plant health and/or food crop yields, which method comprises the application of a plant treatment composition according to claim 1 to a plant, plant part or crop.

9. A method according to claim 8, wherein the plant treatment composition is applied to tomato plants for controlling the incidence and spread of undesired bacterial pathogens, e.g., bacterial spot, such as may be caused by genus Xanthomonas, e.g, Xanthomonas campestris pv. vesicatoria; bacterial speck, such as may be caused by genus Pseudomonas e.g., Pseudomonas syringae PV tomato; and citrus canker, such as may be caused by genus Xanthomonas e.g., Xanthomonas axonopodis pv. citri.

10. A method according to claim 8, wherein the plant treatment composition is applied to citrus plants for controlling the incidence and spread of citrus canker, such as may be caused by genus Xanthomonas e.g., Xanthomonas axonopodis pv. citri.
